(19) United States
(12) Patent Application Publication
(10) Pub. No.: US 2008/0294506 A1
(43) Pub. Date: Nov. 27, 2008

(54) Method and a tool for measuring the formation and effects of workplace friendships

(76) Inventor: Hilla Dotan, Los Angeles, CA (US)

Correspondence Address: Hilla Dotan, 1151 Amherst Ave. #10, Los Angeles, CA, 90049, US

(21) Appl. No.: 12/154,520

(22) Filed: May 24, 2008

Related U.S. Application Data
(60) Provisional application No. 60/931,938, filed on May 24, 2007.

(51) Int. Cl. G06Q 90/00

(52) U.S. Cl. 705/11

(57) ABSTRACT

A method and a tool to measure workplace friendship formation and its effects on individual and organizational job outcomes. The tool comprises one or more items that measure the formation of workplace friendships (1). Various items measure different or overlapping categories. The items are presented as a survey (45) that an individual or a plurality of individuals complete (46, 59). After the individual completes the survey, the scores on the items that measure each of the different categories of formation is aggregated (47) and divided by the number of items per category (48, 60). A total score is calculated per category allowing comparison of the scores on each of the various categories of workplace friendship formation (49). The category with the highest score is an individual's “relational tendency” (51). After an individual identifies his/her workplace friendship formation and relational tendency, he/she may complete an additional survey on outcomes of interest (52, 61). After completing this survey and calculating the scores on the individual outcomes (53, 54), and/or organizational outcomes for a plurality of individuals (62,63) relevant statistical computations are to be performed (55, 64) to examine the relationship between workplace friendship formation and the outcomes of interest. This regression analysis or a statistically equivalent test leads to results (56, 65) that illustrate (through workplace friendship formation) how and why workplace friendships have the effects on the job outcomes of interest.

### CROSS-REFERENCE TO RELATED APPLICATIONS

This application claims the benefit of Provisional Patent Application (PPA) Ser. No. 60/931,938, filed 2007 May 24.

### FEDERALLY SPONSORED RESEARCH

Not applicable

### SEQUENCE LISTINGS OF PROGRAM

Not applicable

### BACKGROUND OF THE INVENTION

1. Field of Invention

This invention relates to workplace friendships, specifically, to a method and a tool to measure the formation of workplace friendships and their effects on the individuals themselves, organizational functioning, efficiency and other business outcomes.

2. Discussion of Prior Art

Workplace friendships are highly prevalent in organizations; however, very limited research has been conducted on such relationships and even less investigation has taken place on the effects of workplace friendships on the individuals themselves as well as their effects on organizational effectiveness and efficiency. The limited research that has examined the effects of these relationships identifies both positive and negative effects of these relationships. Generally, workplace friendships are said to have positive effects on individual outcomes such as stress relief, creativity, job involvement, and job satisfaction. By contrast, scholars have also identified the negative outcomes of workplace friendship ties such as loss of focus on the task, stimulating groupthink, creating conflict of interest situations, and appearance of favoritism. Workplace friendships can also lead to the development of romantic relationships which can be detrimental to individuals and the organization. Although scholars have identified the positive and negative effects of these relationships, they have not been able to account or explain why workplace friendships have these effects, likewise, no theories have been proposed as to why friendships at work have these effects on individuals and the organization. Furthermore, the process of workplace friendship formation has also not been examined. There are no existing tools, measures, or methods to measure the formation of workplace friendships. Moreover, there aren't any models, studies, empirical tests or even theories that suggest ways in which the formation of workplace friendships could be used to explain how workplace friendships affect individuals, organizational functioning or how the formation of workplace friendships affect job-related outcomes such as organizational commitment, job involvement, job satisfaction, employee motivation, turnover, absenteeism, organizational citizenship behavior, or performance. Currently, there are no tools or methods to measure the formation of workplace friendships, or methods that can explain how and why workplace friendships affect individual and organizational outcomes in the manner that they do. This invention fills the aforementioned gaps and provides a method and a tool to measure the formation of workplace friendships, and presents a model that can be used to test how and why workplace friendship formation affects various individual, organizational and business outcomes.

Given that organizations are filled with friendships, and these friendships can have substantial consequences for the individuals themselves and the organizations, a method and a tool (described herein) that can identify why individuals form friendships at work can have substantial value for individuals and organizations.

### SUMMARY

In accordance with the present invention, a workplace friendship formation tool is disclosed and can be applied to measure why individuals form friendships at work, identify a person's “relational tendency”, and examine how workplace friendships affects various individual and organizational outcomes.

### BRIEF DESCRIPTION OF THE FIGURES

These and other objects, features and advantages of the invention will become apparent from a consideration of the detailed description of the invention when read in conjunction with the drawing figures, in which:

FIG. 1 shows the relationship between workplace friendship formation, workplace friendship/s and individual level and organizational level outcomes.

FIG. 2 shows a breakdown of potential categories measuring workplace friendship formation wherein each category represents a different reason for the formation of a workplace friendship (second level in the diagram) and further wherein for each category, there are a number of items that measure the specific reason for workplace friendship formation.

FIG. 3 is a sample of a workplace friendship formation survey which includes all the items from FIG. 2 in the form of statements and which depicts a total of 33 statements, each of which represents an item that measures one of the six categories/reasons of workplace friendship formation.

FIG. 4 is a flow chart illustrating a preferred embodiment of the process and the steps an individual would follow in order to test the relationship between workplace friendship formation and individual and/or organizational outcomes.

FIG. 5 is a flow chart illustrating a preferred embodiment of process and steps a plurality of individuals would follow in order to test the relationship between workplace friendship formation and individual and/or organizational outcomes for a plurality of individuals including but not limited to teams, entire organizations, countries etc.

### DETAILED DESCRIPTION

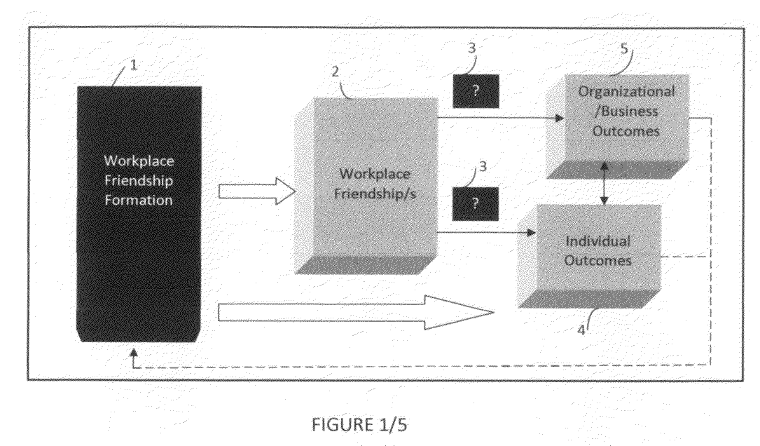

A preferred embodiment of the present invention is illustrated in FIGS. 1-4. FIG. 1 is a conceptual model depicting the relationship between Workplace Friendship Formation 1, Workplace Friendship/s 2, Individual Outcomes 4, and Organizational/Business Outcomes 5. FIG. 1 demonstrates that there is both a direct and indirect effect between workplace friendship formation and the outcomes. An indirect effect means that the effects of workplace friendship formation on the outcomes are mediated by the workplace friendship. In other words, workplace friendship formation leads to a workplace friendship which leads to the individual and organizational outcomes. (It is important to note that the individual and organization/business outcomes can also affect the formation of workplace friendships (reverse causality) as depicted by the dotted arrows in FIG. 1).

Since to date, no one has been able to explain how and why workplace friendships lead to the different individual and organizational outcomes, the box with a question mark represents a “black box” 3 which this invention uncovers. The invention presented herein demonstrates that workplace friendship formation is one explanation for how and why workplace friendships lead to the different outcomes. The model does not limit the “black box” only to the workplace friendship formation explanation. In other words, there are other additional explanations as to how and why workplace friendships may have these effects on the outcomes. Although this invention focuses on workplace friendship formation, it is not limited by such. Any other explanations as to why workplace friendships affect outcomes which are in according with the method/s described herein are embraced as part of this invention. FIG. 1 generally represents the concept of the invention wherein by understanding workplace friendship formation we can begin to understand how and why friendships at work affect outcomes.

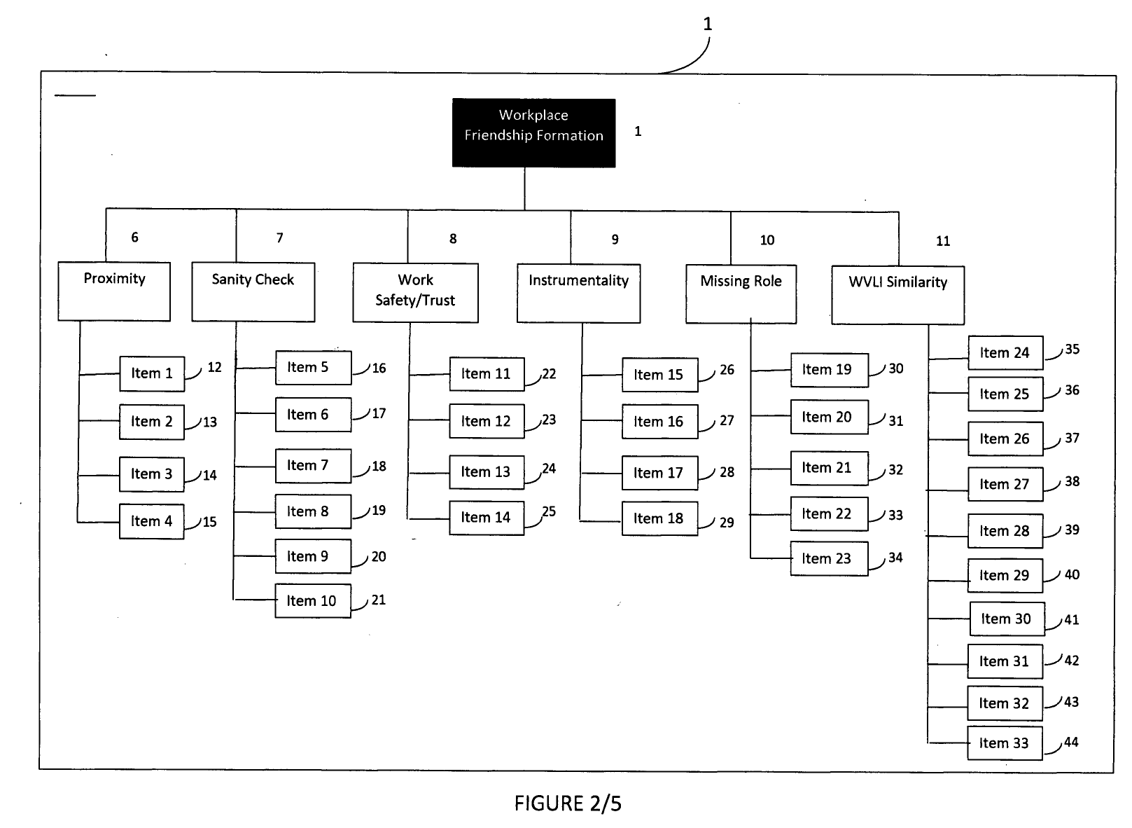

Workplace Friendship Formation 1 is explicated in FIG. 2. FIG. 2 can be thought of as “zooming in” into component 1 in FIG. 1. FIG. 2 represents the components of a tool that measures workplace friendship formation. FIG. 2 is an example of how workplace friendship formation may be measured. Specifically, in this example the construct “workplace friendship formation” is a measure of the reason/s for the formation of a workplace friendship. Six different reasons for formation are included in the diagram: “Proximity” 6, “Sanity Check” 7, “Work Safety/Trust” 8, “Instrumentality” 9, “Missing Role” 10, and “WVLI Interests Similarity” 11. These six reasons for workplace friendship formation are only some categories for the formation of workplace friendships and there may be other reasons for friendship formation at work that could be considered under “Workplace Friendship Formation” 1. The example in FIG. 2 does not limit the number and type of categories that could be included under “Workplace Friendship Formation”.

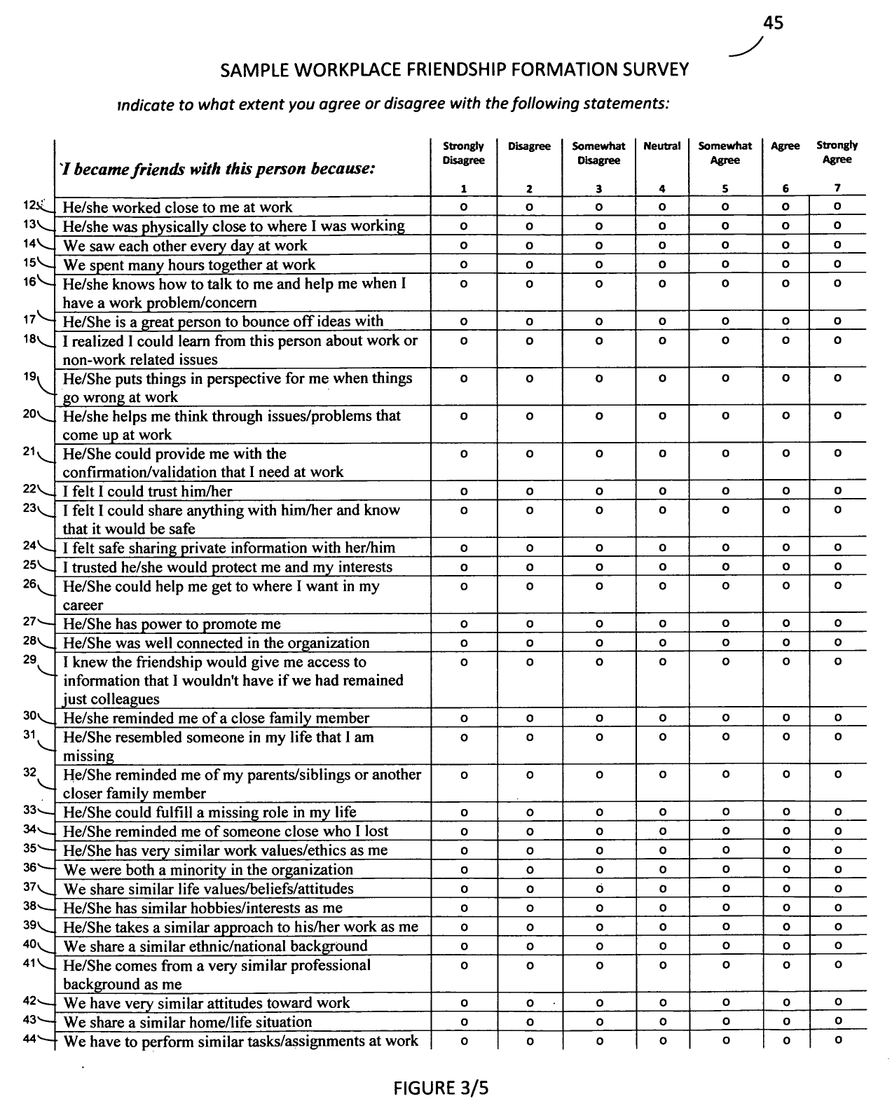

Proximity 6 is a reason for workplace friendship formation that is based on the idea that an individual or individuals formed a friendship at work because they were proximate to one another. Proximity could be both physical propinquity or any other proximity. In the example in FIG. 2, Proximity 6 is measured by 4 items: Item 1 12, Item 2 13, Item 3 14, Item 4 15. Each of these “items” is equivalent to a specific statement in the “Workplace Friendship Formation Survey” (to be discussed as part of FIG. 3). Item 1 12 is a survey statement that is included in the “Workplace Friendship Formation Survey” that reads as follows: “I became friendship with this person because he/she worked close to me at work”. As will be discussed in the discussion on FIG. 3, an individual that takes the survey indicates on a (conventional) Likert type scale that runs from 1 to 7 where 1 is “Strongly Disagree and 7 is “Strongly Agree” his or her agreement with the above statement. He/she indicates his/her dis/agreement for all the items on the “Workplace Friendship Formation Survey”. Item 2 13 is a similar survey statement on the same survey that reads as follows: “I became friendship with this person because he/she was physically close to where I was working”. Item 3 14 reads as follows: “I became friends with this person because we saw each other every day at work”. Item 4 15 reads: “I became friends with this person because we spent many hours together at work”.

Sanity Check 7 is a reason for workplace friendship formation that is based on an intrinsic cognitive need to validate one's way of thinking and get a cognitive confirmation from another. In the example in FIG. 2, Sanity Check 7 is measured by 6 items: Item 5 16, Item 6 17, Item 7 18, Item 8 19. Item 9 20, and Item 10 21. Item 5 16 reads as follows; “I became friends with this person because He/she knows how to talk to me and help me when I have a work problem/concern”. Item 6 17 reads as follows; “I became friends with this person because he/she is a great person to bounce off ideas with “.”, Item 7 18 reads as follows; “I became friends with this person because I realized I could learn from this person about work or non-work related issues”. Item 8 19 reads as follows; “I became friends with this person because he/she puts things in perspective for me when things go wrong at work”. Item 9 20 reads as follows; “I became friends with this person because He/she helps me think through issues/problems that come up at work”. Item 10 21 reads as follows; “I became friends with this person because he/she could provide me with the confirmation/validation that I need at work”.

Work Safety/Trust 8 is a reason for workplace friendship formation that is based on an internal feeling of safety that results from an external trigger; trust of another. In other words, when an individual perceives that another (hence external) is trustworthy, a positive, internal feeling of safety is achieved which motivates him/her to get closer to the other and form a friendship. In the example in FIG. 2, Work Safety/Trust 8 is measured by 4 items: Item 11 22, Item 12 23, Item 13 24, Item 14 25. Item 11 22 reads as follows; “I became friends with this person because I felt I could trust him/her”. Item 12 23 reads as follows; “I became friends with this person because I felt I could share anything with him/her and know that it would be safe”. Item 13 24 reads as follows; “I became friends with this person because I felt safe sharing private information with her/him”, and Item 14 25 reads as follows; “I became friends with this person because I trusted he/she would protect me and my interests”.

Instrumentality 9 is a reason for workplace friendship formation that is based on the idea that individuals pursue a friendship relationship with a work colleague with the hope that the friendship will then leverage some instrumental benefits such as a career advancement, pay increase, and other rewards that they may have not received without the friendship even if they were well-deserved. In the example in FIG. 2, Instrumentality 9 is measured by 4 items: Item 15 26, Item 16 27, Item 17 28, Item 18 29. Item 15 26 reads as follows; “I became friends with this person because he/she could help me get to where I want in my career”. Item 16 27 reads as follows; “I became friends with this person because he/she has power to promote me”. Item 17 28 reads as follows; “I became friends with this person because he/she was well connected in the organization”, and Item 18 29 reads as follows; “I became friends with this person because I knew the friendship would give me access to information that I wouldn't have if we had remained just colleagues”.

Missing Role 10 is a reason for workplace friendship formation that is based on the notion that individuals pursue a friendship at work with a specific colleague to satisfy some critical missing role in their lives. In the example in FIG. 2, Missing Role 10 is measured by 5 items: Item 19 30, Item 20 31 Item 21 32, Item 22 33. Item 23 34. Item 19 30 reads as follows; “I became friends with this person because he/she reminded me of a close family member”. Item 20 31 reads as follows; “I became friends with this person because he/she resembled someone in my life that I am missing”. Item 21 32 reads as follows; “1 became friends with this person because he/she reminded me of my parents/siblings or another closer family member”. Item 22 33 reads as follows; “I became friends with this person because he/she could fulfill a missing role in my life Item 23 34 reads as follows; “I became friends with this person because he/she reminded me of someone close who I lost”.

WVLI Similarity 11 or Work-Values Life Interests (WVLI) Similarity is a reason for workplace friendship formation that is based on the ideas that co-workers become friends with one another based on shared work-values and/or life interests. In the example in FIG. 2, WVLI Similarity 7 is measured by 10 items: Item 24 35, Item 25 36, Item 26 37, Item 27 38. Item 28 39 Item 29 40, Item 30 41, Item 31 42. Item 32 43 Item 33 44. Item 24 35 reads as follows; “I became friends with this person because he/she has very similar work values/ethics as me”. Item 25 36, reads as follows; “I became friends with this person because we were both a minority in the organization”. Item 26 37 reads as follows; “I became friends with this person because we share similar life values/beliefs/attitudes Item 27 38 reads as follows; “I became friends with this person because he/she has similar hobbies/interests as me.” Item 28 39 reads as follows; “I became friends with this person because he/she takes a similar approach to his/her work as me”. Item 29 40 reads as follows; “I became friends with this person because we share a similar ethnic/national background.”. Item 30 41 reads as follows; “I became friends with this person because he/she comes from a very similar professional background as me”. Item 31 42 reads as follows; “I became friends with this person because we have very similar attitudes toward work”. Item 32 43 reads as follows; “I became friends with this person because we share a similar home/life situation “. Item 33 44 reads as follows;” I became friends with this person because we have to perform similar tasks/assignments at work”.

As mentioned, the aforementioned six reasons for friendship formation are only some categories for the formation of workplace friendships and there may be other reasons for friendship formation at work that could similarly exist and be considered under “Workplace Friendship Formation” 1. Furthermore, Workplace Friendship Formation is not limited to the six reasons for the formation as illustrate herein. It may include the process of friendship formation which may include a process measure that considers the dynamic aspect of friendships and measures friendships at one point in time, in retrospect, or over time. Anything that has to do with why a friendship at work was formed, is forming, will form, how it was formed, for what purpose, under which conditions, etc is included under the general construct “Workplace friendship formation” 1 and as such, embraced by the invention discloses herein. FIG. 2 is one example of how workplace friendship formation may be measured. This invention covers anything that has to do with the formation of a workplace friendship and is not limited by the example provided.

FIG. 3 is a sample of a workplace friendship formation survey. It includes all the items from FIG. 2 in the form of statements. There are a total of 33 statements each representing an item that measures one of the six categories of workplace friendship formation. The first four items (12, 13, 14, 15), or statements in the list measure the reason for workplace friendship formation “Proximity” 6 the next six items (16,17,18,19,20,21) measure the reason for workplace friendship formation “Sanity Check” 7, the next four items (22,23,24,25) measure “Work Safety/Trust” 8, the next four items (26,27,28,29) measure “Instrumentality” 9, the next five statements (30,31,32,33,34) measure “Missing Role” 10, and the final ten statements (35,36,37,38,39,40,41,42,43,44) measure WVLI Similarity 11.

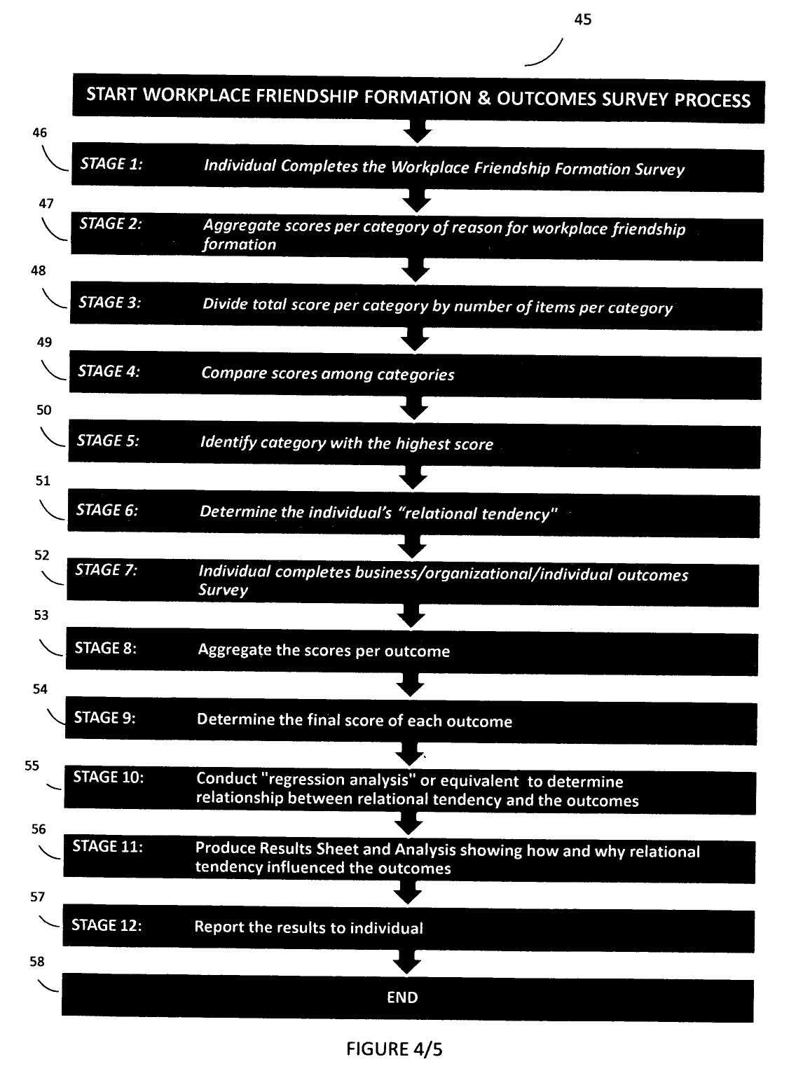

An individual that takes this survey is required to fill in the circles or highlight the appropriate response for each statement. Thus, for example, for the first statement, the individual has to indicate whether he/she strongly agrees, somewhat agrees, agrees, is neutral, disagrees, somewhat disagrees, or strongly disagrees with the statement: “I became friends with this person because he/she worked close to me at work”. An individual must complete the entire survey and once he/she is finished responding to all the 33 statements, he/she may begin calculating the score and the results of the survey (this process will be discussed in detail under FIG. 4). A score is calculated for each of the six reasons for workplace friendship formation. The reason for workplace friendship formation with the highest score is the individual's “relational tendency”. If the individual has the same top score for one or more of the reasons for workplace friendship formation, the relational tendency would include all the respective reasons in which the score was the same. In this sample survey the items per category appear one after another. However, it is best to mix the questions around and not have items that measure the same category appear one after the other when one is taking the survey. It is also a good idea to include additional ‘fill in’ questions that do not measure the six items at all so as to minimize common survey biases. Although this survey is presented in a paper format, it can be as part of an online survey or another similar approach. The format presented here is only a sample and should not limit the format/method that the survey can take and/or be administered under this invention. Furthermore, as previously mentioned, other statements that do not appear on this survey may likewise me included in the survey which is not limited to the content or number of statements depicted in the example. In this sense, the survey may be tailored to a particular audience it is intended to engage. This would result in surveys that vary in both content and number of statements they present. There may be numerous variations of the inquiry intent of the survey and the above example that uses “I became friend with . . . ” is not limited to such intent.

FIG. 4 is a flow chart illustrating a preferred embodiment of process and steps an individual would follow in order to test the relationship between workplace friendship formation and individual and/or organizational outcomes. This process allows a person to collect the appropriate data, conduct the necessary analyses and derive conclusions about how and why workplace friendship/s can lead to various individual and organizational outcomes. In Stage 1 46 an individual completes a workplace friendship formation survey such as the one provided in FIG. 3. In stage 2 47, the scores are aggregated per category of reason for workplace friendship formation. Aggregation of the score can be explained as follows: a response “Strongly Disagree” receives a score of 1, a response “Disagree” receives a score of 2, a response “Somewhat disagree” receives a score of 3, a response of “Neutral” receives a scores of 4, a response “Somewhat Agree” receives a scores of 5, a response of “Agree” receives a scores of 6, a response of “Strongly Agree” receives a score of 7. For example, an individual who indicated that she “Agrees” with the first 4 statements in FIG. 3, would get at total raw score of 6×4=24 for Proximity 6. If the same individual indicated that she “Somewhat Agreed” with the next two statements (16 and 17), and was “Neutral” on the following four (18,19,20,21), her score on Sanity Check 7 would be: [(2×5)+(4×4)]=26. The same procedure should be followed for the next 23 items. An aggregate score per reason for workplace friendship formation should be derived at this stage following the above procedure for all the reasons of workplace friendship formation. As an hypothetical example, let us assume that the total score for Work Safety/Trust 8 is 20, for Instrumentality 9 is 16, for Missing Role 10 the total raw score is 30, and for WVLI Similarity 11 it is 40. In Stage 3 48, we will divide the total raw score of each reason for formation from Step 2 by the number of items per category. Using the above example, for Proximity the score would be 24/4=6, for Sanity Check 26/6=4.33, for Work Safety/Trust 20/4=5, for Instrumentality 16/4=4, for Missing Role, 30/5=6, and for WVLI Similarity 40/10=4. In Stage 4 49, we will compare the scores among the different reasons: [6, 4.33, 5, 4, 6, 4]. In stage 5 50, we will identify the category with the highest score. In the above hypothetical example we see that both Proximity and Missing Role have the highest score (value of 6) relative to the other reasons of workplace friendship formation.

In stage 6 51, the “Relational Tendency” will be determined. As mentioned, the Relational Tendency is the reason for workplace friendship formation with the highest score/s. Given that in the above example, we have two reasons with equal scores, the relationship tendency for this example is both Missing Role and Proximity. This means that the individual who completed this survey has a tendency to form friendships at work mainly because of Proximity and Missing Role. In other words this individual has a tendency to form friendships with those who are physically close to her and has a tendency to form friendships at work to satisfy some missing role in her life. In instances where the individual was only interested in identifying his/her workplace friendship formation, relational tendency, there would be no need to continue to Stage 7 and this would be the end of this process. However, an individual who is interested in testing whether there is a relationship between his/her workplace friendship formation and his/her job outcomes would continue to the next steps in this process. In Stage 7, 52 the individual would complete an additional survey that measures the individual and/or organization/business outcomes. This additional survey would be an individual level outcomes survey, business outcomes, or organizational level outcomes survey which is typical in the field. Numerous ways and tools of measuring individual level and organizational level outcomes have been developed my researchers. Some examples of individual level outcomes are: Job Involvement, Organizational Commitment, Employee Motivation, Intention to Turnover, Organizational Citizenship Behaviors, Absenteeism, Job Satisfaction, Individual Performance etc. Measure of organizational or business outcomes that researchers have produced include team performance, productivity, information sharing, organizational effectiveness, revenue etc. For example, let's assume that the individual who is completing this process is only interested in her own individual level outcomes such as Job involvement and Job Satisfaction. She would then complete the existing and available survey measures on Job Involvement and Job Satisfaction. It will be a very similar process to the one for filling in the Workplace Friendship Formation survey. In Stage 8 53, she would need to aggregate the scores per job outcome, and in Stare 9 54 determine the final score on each individual level outcome of interest. In Stage 10 55, he/she would need to conduct a “Regression Analysis” or an equivalent statistical procedure to determine the relationship between her scores on workplace friendship formation and Job Involvement and Job Satisfaction. Regression Analysis and other statistical procedures should be conducted by a person who is skilled in the art, the procedures of which are well known in the state of the art an thus, there is no need to elaborate on such techniques herein. What is important to note however, is that in the regression analysis both causes directions can be examined. In other words, both the effects of workplace friendship formation on outcomes an the effects of outcomes on workplace friendship formation can be tested and reported. In Stage 11 56 the results of the statistical analyses should be documented. The results should be written in such a way that it is clear what the relationship is between the different reasons of workplace friendship formation and the job outcomes, including but not limited to causality. These results will clarify which reason for friendship formation had the strongest most in/significant relationship with Job Satisfaction and Job Involvement. In Stage 12 57, if the statistical analyses were conducted by an expert in that field, a report explaining the results in lay terms should be provided to the individual who completed the surveys. By following all the aforementioned steps, an individual would be able to determine the relationship between his/her relational tendency and any of the other reason for workplace friendship formation and any outcome of interest. The findings will help explain which reason for workplace friendship formation is more or less important for each of the outcomes, thus helping explain some of the “black box” 3, (FIG. 1) of how and why workplace friendships affect outcomes.

The above example was about a single individual and her results. However, the value and benefits of this procedure increases when the same procedure is completed by many individuals. For example, an organization can have all the employees go through the survey process described in FIG. 4 and derive results about the relational tendencies of all the employees as well as the relationship between the employees workplace friendship formation and both individual and organizational outcomes. In this case, we would be able to understand the relational tendencies in the organization, as well as learn about the effects of workplace friendships for all the employees. This can help identify patterns of behavior among employees and the effects of these on organizational functioning and efficiently well beyond what is currently known using the limited research and lacking tools in the current research on workplace friendships and workplace friendship formation.

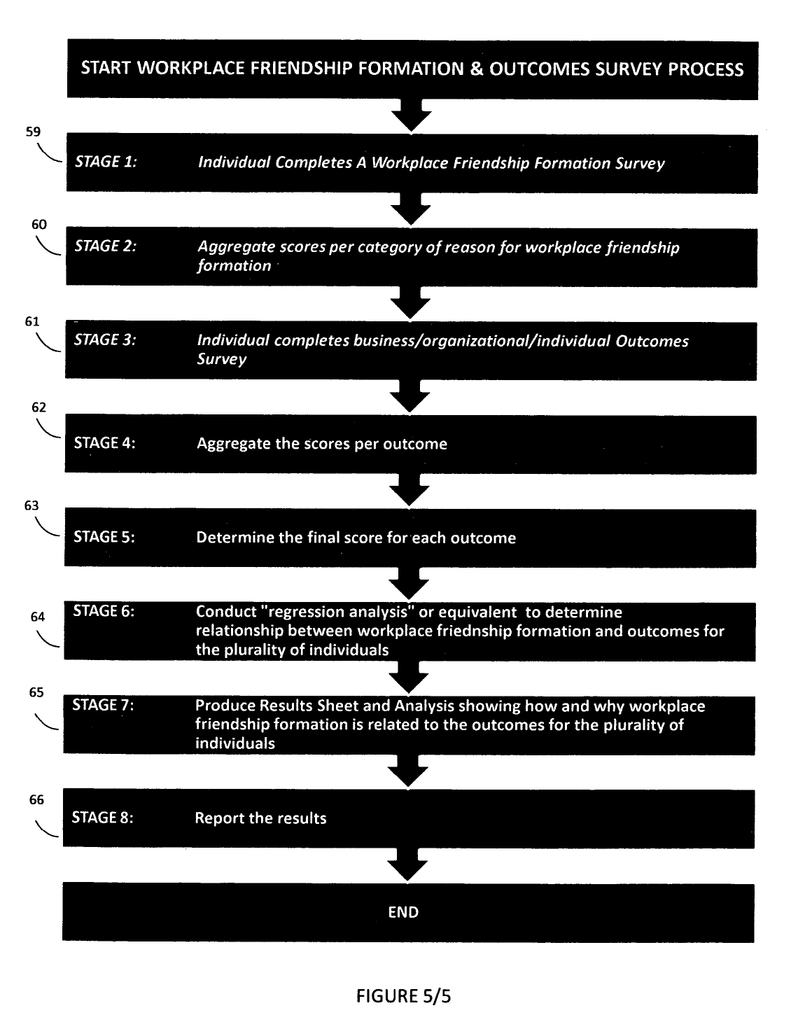

FIG. 5 is a flow chart illustrating a preferred embodiment of process and steps a plurality of individuals would follow in order to test the relationship between workplace friendship formation and individual and/or organizational outcomes for a plurality of individuals including but not limited to entire organizations, countries etc. In Stage 1 59 each person of the plurality of individuals completes a workplace friendship formation survey such as the one provided in FIG. 3. In stage 2 60, the scores per category of reason for workplace friendship formation are calculated in the same manner described above for stage 2 and stage 3 in FIG. 4. In Stage 3 61, each individual would complete an additional survey that measures the individual and/or organizational/business outcomes. This additional survey would be an individual level outcomes survey, business outcomes, or organizational level outcomes survey which is typical in the field. For example, let's assume that an organization is interested in having all its employees complete both the workplace friendship formation survey and the individual and organizational outcomes surveys given that they are interested in determining the pattern of workplace friendship formation amongst their employees and the relationship between workplace friendship formation and the individual and organizational outcomes for the entire organization. In Stage 3 61, for the example above all the employees would complete a survey that comprises both individual level outcomes (e.g. Organizational Commitment, Turnover Intentions) and organizational level outcomes (e.g. Performance, Productivity). In Stage 4 62 scores per outcome for all the plurality of individuals would be calculated and in Stage 5 63 the final score on each outcome of interest would be determined for the plurality of individuals. In Stage 6 64, a “Regression Analysis” or an equivalent statistical procedure would be conducted to determine the relationship between the scores on workplace friendship formation and the outcomes of interest for the plurality of individuals. Regression Analysis and other statistical procedures should be conducted by a person who is skilled in the art, the procedures of which are well known in the state of the art an thus, there is no need to elaborate on such techniques herein. In Stage 7 65 the results of the statistical analyses should be documented. The results should be written in such a way that it is clear what the relationship is between the different reasons of workplace friendship formation and the job outcomes for all the plurality of individuals. These results will clarify which reason for friendship formation had the strongest most in/significant relationship with outcomes and demonstrate how and why workplace friendship formation is related to the various individual and organizational/business outcomes. In Stage 8 66, if the statistical analyses were conducted by an expert in that field, a report explaining the results in lay terms should be produced so that any of the employees or any of the individuals involved could understand the patters of workplace friendship formation for the plurality of individuals (employees in this organization), and how this is related or affects the outcomes. By following all the aforementioned steps, an individual or a group of individuals would be able to determine the relationship between any of the reason for workplace friendship formation (and the relational tendency of a plurality of individuals) and any outcome of interest for those plurality of individuals. The findings will help explain which reason for workplace friendship formation is more or less important for each of the outcomes, thus helping explain some of the “black box” 3, (FIG. 1) of how and why workplace friendships affect outcomes for many individuals and not merely one. The process outlined above, allows for identification of patterns of behavior in teams, organization and nations which can have substantial benefits. This is one preferred embodiments for how the method discussed herein would work with a plurality of individuals but is not limited to such.

It is important to note (as briefly mentioned above) that the process outlined above suggests a method for examining how workplace friendship formation may affect job outcomes. However, the same method can also be used to test how job outcomes influence workplace friendship formation (reverse causality, as depicted by the dotted arrows in FIG. 1). This is taken into consideration in the regression analysis testing in Stage 10, FIG. 4, and Stage 6, FIG. 5 and the reverse direction could be examined. The present invention is not limited to a particular directionality, and the reverse direction could be examined as well.

A tool such as but not limited to the example/s provided in this invention can have additional benefits above and beyond those discussed above. Some of the advantages of the present invention are:
a) To provide a tool that can identify why individuals form friendships at work
b) To provide a tool that can be easily used by any individual or organization
c) To provide a tool and a model that can be used to explain why some workplace friendships affect individual and organizational outcomes positively and others negatively
d) By knowing which type of friendships lead to positive outcomes, and which lead to negative outcomes, organizations can help facilitate the formation of the potentially positive workplace friendships and inhibit the formation of the negative workplace friendships. This can have substantial benefits (psychosocial, financial and other benefits) to individuals and organizations. For example, if through application of the aforementioned invention, organizations identify the reasons for workplace friendship formation that have negative effects on outcomes such as a low job satisfaction, low performance level, more turnover, they can influence the formation of such relationships. For instance, a manager of an organization that followed the procedure outlined in FIG. 5 for 200 of his employees and identified that most of the employees in the department that was not functioning well formed friendships on the basis of instrumentality and instrumentality was shown to have a negative correlation with job satisfaction and performance (through the regression Analysis in Step 6, FIG. 5), now has additional insight into why the team was not performing well. Such a manager can decide to implement an intervention program to help inhibit the formation of workplace friendships that are based on instrumentality. He/she can do so through various training programs, avoid recruiting individuals who are expected to form friendships on the basis of instrumentality. This can be determined by requiring a job candidate to complete the workplace friendship formation survey (FIG. 3) and following the process in FIG. 4, steps 1-6. A manager can implement any other programs that can minimize the effects of friendships that are formed on the basis of instrumentality. Similarly, the manager can use the insight derived from following the procedure outlined in this invention about the friendships that were formed as a result of reasons for formation that had positive effects to implement an intervention program to facilitate the formation of the potentially positive workplace friendships such as Work Safety/Trust. This can be done through facilitating a culture that is based on safety and trust. This example serves to suggest only some of the many potential benefits of this invention for individuals and organizations alike.
e) To provide a method for influencing the formation of different types of workplace friendships.
f) To provide a tool to identify an individual's or a team's ‘relational tendency’
g) To provide a tool that can assist in recruiting decisions
h) To provide a tool that can assist in providing improved training for employees about their workplace relationships and how to manage them effectively
i) To provide a tool that can assist in implementing an intervention program aimed at influencing workplace friendship formation
j) To provide a tool to help organizations and managers manage the relationships that form within their organizations for improved business efficiency and effectiveness
k) To provide a tool for individuals to facilitate the formation of workplace friendship for reasons that can lead to positive outcomes for themselves

Further advantages are to provide any individual and organization a way to identify the main reason for the formation of his/her workplace friendship and which can be used repeatedly and over time and can be investigated to examine any type of individual and organizational outcomes. Thus, allowing companies to examine the effects of workplace friendship formation on any outcomes of interest to them at any time, and over time.

It should be further mentioned that the above method could likewise be applied to determine the process of workplace friendship formation. Such a procedure would incorporate a method similar to the above method for determining the reasons of workplace friendship formation and would preferably be administered on a repeated basis throughout the course of a pre-determined time period. It should be noted that the method for determining the process of workplace friendship formation for an individual and a plurality of individuals respectively would include following only stages 1-6 in FIG. 4, and stages 1-2 in FIG. 5. For example, if the above method (Stages 1-6 in FIG. 4) is repeated four times a year for an individual such would result in determination of the process of workplace friendship formation for that year.

Although the description above contains many specificities, these should not be construed as limiting the score of the invention but as merely providing details of some of the utilities of this invention. For example, the tool can be applied to other settings besides the workplace and examine the formation of friendships outside work. Similarly, it can be used to identify the formation of other relationships at work and examine the effects of these on outcomes etc. Thus, the scope of the invention should be determined by the appended claims and their legal equivalence, rather than by the examples given.

I claim:

1. A method for determining workplace friendship formation for an individual compromising:
a. Requiring an individual to complete a workplace friendship formation survey
b. Calculating the scores per category of workplace friendship formation
c. Identifying the category with the highest score
d. Determining the individual's Relational Tendency

2. The method of claim 1 wherein the aggregate scores per category pertain to the reasons for workplace friendship formation

3. The method of claim 1 wherein the aggregate scores per category pertain to the process of workplace friendship formation

4. The method of claim 1 further comprising the steps of:
a. Requiring an individual to complete a business, organizational, or individual-level outcomes survey or a combination thereof
b. Calculating the scores per outcome
c. Conducting a regression analysis or an equivalent statistical procedure to determine the relationship between workplace friendship formation and the outcomes
d. Producing a results sheet and analysis showing how workplace friendship formation is related to the outcomes
e Reporting the results and finding
